(19) United States
(12) Patent Application Publication
(10) Pub. No.: US 2015/0351431 A1
(43) Pub. Date: Dec. 10, 2015

(54) MANUFACTURING METHOD OF WHOLE-GRAIN RICE POWDER AND WHOLE-GRAIN RICE POWDER OBTAINED BY THE MANUFACTURING METHOD

(71) Applicant: SATAKE CORPORATION, Chiyoda-ku, Tokyo (JP)

(72) Inventors: Takeshi Fukumori, Hiroshima (JP); Hidenori Mizuno, Hiroshima (JP); Tsuyoshi Fujishima, Hiroshima (JP)

(21) Appl. No.: 14/762,812

(22) PCT Filed: Feb. 10, 2014
(86) PCT No.: PCT/JP2014/053076

§ 371 Date: Jul. 23, 2015

(30) Foreign Application Priority Data
Feb. 15, 2013 (JP) 2013-027374

(51) Int. Cl. A23L 1/10; A23L 1/00

(52) U.S. Cl. CPC A23L 1/1041; A23L 1/002; A23V 2002/00

(57) ABSTRACT

A method of obtaining whole-grain rice power with higher added value by using brown rice after GABA enriching treatment to unhulled rice, in which heated/humidified air is applied to the unhulled rice, treatment for enriching a GABA content contained in the unhulled rice is executed and then, the unhulled rice is dried to a predetermined moisture and subsequently, the unhulled rice is hulled to obtain brown rice, the brown rice is subjected to grain-sorting so as to extract immature rice, and the immature rice is milled to obtain the whole-grain rice powder, whereby a high added value can be given to immature rice which conventionally only had to be sold inexpensively.

### TECHNICAL FIELD

The present invention relates to a manufacturing method of whole-grain rice powder from brown rice in which γ-aminobutyric acid (GABA) (hereinafter referred to as “GABA”) is enriched and the whole-grain rice powder obtained by the manufacturing method.

### BACKGROUND ART

Conventionally, polished rice obtained by applying GABA enriching treatment for enriching GABA to unhulled rice and brown rice and then, by performing rice polishing is known. Means for enriching GABA is described in Patent Document 1, for example, in which humidified air at a high temperature and a high humidity is applied to the brown rice and then, the blowing of air is stopped and the brown rice is left at rest for a certain period of time and dried and then, polished to polished rice. Moreover, application of the GABA enrichment treatment to the unhulled rice collected to a country elevator by using a country elevator (large-sized drying and preparation facilities) and the like installed at a rice-producing area is also proposed (Patent Document 2). In this case, since the brown rice is heated/humidified through rice husk on a surface, rice grain cracks are generated less easily than direct humidification of the brown rice. Thus, the GABA enriching treatment can be executed in a shorter time than the GABA enriching treatment of the brown rice, and a rice crashing rate in the subsequent rice polishing is small.

Recently, the rice powder draws attention as a substitute for flour in our country. In a health-oriented trend, whole-grain powder obtained by milling the whole brown rice containing skin, germ, and endosperm has drawn attention as high value added rice powder with a higher nutrition value than the other rice powders.

### LIST OF CITATIONS

### Patent Documents

Patent Document 1 Japanese Patent Laid-Open No. 2007-215504

Patent Document 2 Japanese Patent laid-Open No. 2012-139236

### SUMMARY OF THE INVENTION

### Technical Problem

An object of the present invention is to provide a method of obtaining the whole-grain rice powder with higher added value by using brown rice after GABA enriching treatment applied to unhulled rice and whole-grain rice powder obtained from the manufacturing method.

### Solution to Problem

Conventionally, when the GABA enriching treatment is applied to the unhulled rice, the unhulled rice after the treatment is hulled to obtain brown rice, and at the same time, this brown rice is subjected to grain-sorting, foreign substances or immature rice are removed, and only well-sized grain brown rice is recovered. The immature rice which is a byproduct in sieving is sold at a low price to crushed rice dealers and the like. The inventors paid attention to the immature brown rice subjected to the GABA enriching treatment. The immature brown rice has amounts of germ and rice bran substantially the same as those of the well-sized grain brown rice but its endosperm is small. When the immature brown rice and the well-sized grain rice are compared, the inventors found that the immature brown rice contains relatively more GABA and reached the present invention.

The manufacturing method of the whole-grain powder of the present invention takes the following technical means: applying heated/humidified air to the unhulled rice; executing treatment of enriching a content of the GABA contained in the unhulled rice on the unhulled rice; drying the unhulled rice to a predetermined moisture amount; hulling the unhulled rice to obtain brown rice, grain-sorting the brown rice so as to select/extract immature rice; and crushing the immature rice to obtain the whole-grain rice powder.

### Advantageous Effect of the Invention

According to the present invention, the immature rice in the brown rice obtained by applying the GABA enrichment to the unhulled rice is selected/extracted and made the whole grain powder. As a result, the high value-added brown rice powder containing relatively more GABA than well-sized grain brown rice can be obtained easily, and not a few economic profits can be gained by the immature rice which only had to be sold inexpensively so far.

### BRIEF DESCRIPTION OF THE DRAWINGS

FIG. 1 is a flowchart illustrating steps of an embodiment of a manufacturing method of a whole-grain powder of brown rice of the present invention.

FIG. 2 is a partially broken side view of a hydrating/drying device for unhulled rice used in the embodiment of the present invention.

FIG. 3 is a partially broken front view of a hydrating/drying device for unhulled rice used in the embodiment of the present invention.

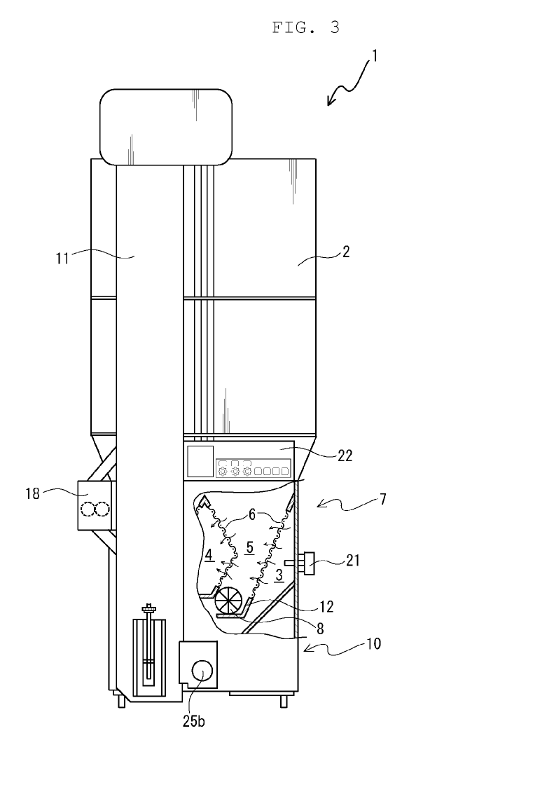

### DETAILED DESCRIPTION

Hereinafter, the present invention will be described in detail on the basis of an embodiment.

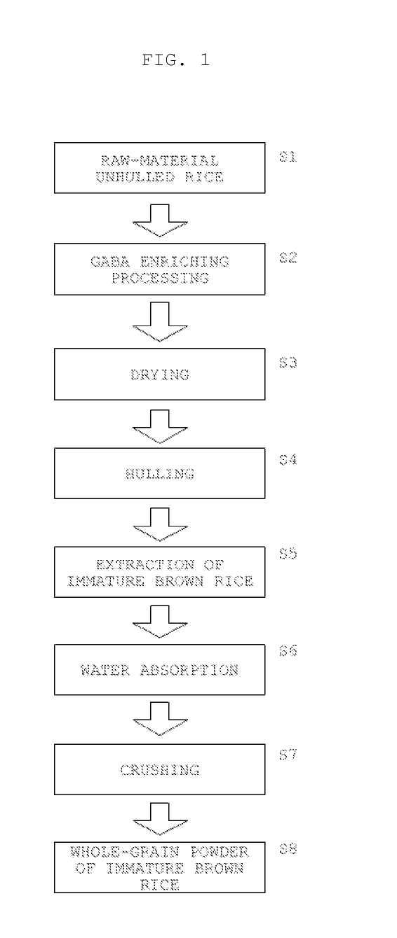

A manufacturing method of whole-grain rice powder according to the present invention is characterized by being performed by the following steps in order as illustrated in FIG. 1:

Prepare unhulled rice which is to be used as a raw material (S1).

Apply humidified hot air to the unhulled rice and execute treatment of enriching a content of GABA contained in the unhulled rice (S2).

Dry the unhulled rice until a predetermined moisture amount is gained (S3).

Hulling the unhulled rice to obtain brown rice (S4).

Subject the brown rice to grain sorting and extract immature rice (S5).

Execute hydrating treatment (S6).

Crush the immature rice (S7).

Obtain whole-grain rice powder (S8).

The hydrating treatment at S6 can be omitted depending on the case.

As described in Patent Document 2, the GABA enriching treatment can be executed for the unhulled rice in a facility such as a country elevator. At that time, the unhulled rice may be in any one of a raw state, a semi-dried state and dried state. In this embodiment, the unhulled rice finished and dried to have a moisture content of 14 to 16% is used.

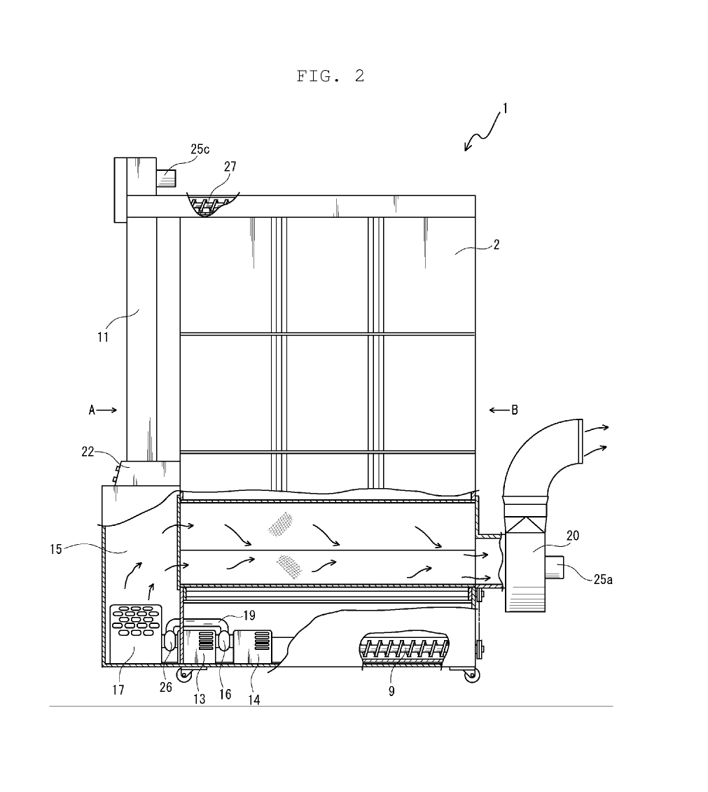

FIG. 2 illustrates a partially broken side view of a hydrating/drying device. The hydrating/drying device 1 has a structure substantially similar to a circulation-type grain dryer used in general. A storing portion 2 for storing unhulled rice, a hydrating/drying portion 7 for applying normal-temperature air or hot air at high humidity to the unhulled rice, and a discharge portion 10 for discharging the unhulled rice of the hydrating/drying portion 7 to an outside of the machine are provided in order from an upper part. In the hydrating/drying portion 7, an air blowing duct 3, an air discharge duct 4, and a grain flow-down tank 5 connected to the storing portion 2 are formed. A space among the air blowing duct 3, the air discharge duct 4, and the grain flow-down tank 5 is divided by a plurality of porous plates 6 disposed between one side A and the other side B in a machine longitudinal direction illustrated in FIG. 2. Moreover, an inclined non-porous plate 12 is provided by being connected to the grain flow-down tank 5. In the discharge portion 10, a discharge valve 8 for intermittently discharging the unhulled rice to a lower end side of the non-porous plate 12 is provided. Below the discharge valve 8, a lower screw conveyer 9 for discharging the unhulled rice fed out of the discharge valve 8 while laterally conveying it is disposed. The discharged unhulled rice is circulated/conveyed to the storing portion 2 through a bucket conveyer 11 and an upper screw conveyer 27.

On an upper part of the bucket conveyer 11, a bucket conveyer motor 25c is provided. Power of the bucket conveyer motor 25c drives not only the bucket conveyer 11 but also the upper screw conveyer 27. Moreover, a taking-out portion motor 25b is provided in the discharge portion 10. The discharge valve 8 and the lower screw conveyer 9 are driven by the taking-out portion motor 25b.

On a lower part on an A side in FIG. 2, a hot-air generating burner 14 using lamp oil or the like as a fuel and a humidifying device 13 are provided. On a lower part on a B side, an air discharge fan 20 having a fan motor 25a is provided. The hot-air generating burner 14 is connected to a channel switching valve 16. The air discharge fan 20 is connected to a B-side end portion of the air discharge duct 4 of the hydrating/drying portion 7 and suctions hot air in the air discharge duct 4 and discharges it to the outside of the machine. In the vicinity of a supply port of the air blowing duct 3 to which the hot air is supplied, a temperature/humidity sensor 21 for detecting a temperature and humidity of the humidified air and the hot air is provided. On one end portion of the bucket conveyer 11, a moisture meter 18 for detecting a moisture value of the grain is provided.

The hot air generated by the hot-air generating burner 14 is suctioned by the air discharge fan 20. In hydrating, the hot air passes through the humidifying device 13 via the channel switching valve 16 and becomes the humidified air. After that, it passes through a ventilation port 17, a preceding air duct 15, the air blowing duct 3, the grain flow-down tank 5, and the air discharge duct 4 and is discharged to the outside of the machine through the air discharge fan 20. In drying, the hot air passes through a bypass air duct 19 by the channel switching valve 16. After that, it passes through the ventilation port 17, the preceding air duct 15, the air blowing duct 3, the grain flow-down tank 5, and the air discharge duct 4 and is discharged to the outside of the machine through the air discharge fan 20.

Driving control in the hydrating/drying device 1 is made by a control portion 22. The control portion 22 stores a program for performing a hydrating operation and a drying operation. The temperature/humidity sensor 21, the moisture meter 18, the humidifying device 13, the hot-air generating burner 14, the channel switching valve 16, the fan motor 25a, the taking-out portion motor 25b, the conveyer motor 25c and the like are connected to the control portion 22. A switch for setting a filled amount of the unhulled rice, a switch for setting a moisture value during hydrating, a switch for setting a finish moisture value and the like are also electrically connected to the control portion 22.

A specific operation of the hydrating/drying device 1 will be described below by referring also to the flowchart in FIG. 1. In the hydrating operation, dry unhulled rice which is a raw material is input into the storing portion 2 and filled (corresponding to preparation of raw-material unhulled rice at S1), and a filled amount and a hydration target moisture value are set by each switch. Subsequently, when a hydrating operation program is executed by a hydrating button and the GABA enriching treatment is started (S2), the air discharge fan 20, the discharge valve 8, and each conveyer are operated, respectively.

The humidifying device 13 and the hot-air generating burner 14 also start operation. Set humidity and temperature of the humidified air passed through the grain flow-down tank 5 are determined on the basis of the unhulled rice filled amount and the hydration target moisture value set at start of the hydrating operation. Then, a combustion level of the hot-air generating burner 14 is changed so that measured values detected by the temperature/humidity sensor 21 become the determined set temperature and humidity. The temperature of the humidified air is set to 65 to 70° C. and the humidity is set to 90 to 98%.

The unhulled rice having flowed down into the grain flow-down tank 5 from the storing portion 2 is hydrated by applying the humidified air generated by the humidifying device 13 and the hot-air generating burner 14. After that, it is discharged from the grain flow-down tank 5 by the discharge valve 8 and circulated/conveyed to the storing portion 2 through the bucket conveyer 11 and the upper screw conveyer 27. This circulation/conveyance is performed for approximately 2 to 4 hours until the moisture value measured at any time by the moisture meter 18 reaches the target moisture value.

When the hydrating operation is finished, circulation/conveyance of the unhulled rice and application of the humidified air are stopped, and the unhulled rice for which hydration has been finished is made to stay at rest in the storing portion 2. Time for staying at rest is set within a range of 2 to 25 hours, but it is preferably 8 to 12 hours and more preferably 9 to 11 hours. As a result, the GABA enriched near germs penetrates into an inside of the endosperm.

After staying at rest, the drying operation is started (S3). A drying finish target moisture value is set, and by operating a drying start switch, a drying operation program is executed. Then, the fan motor 25a, the taking-out portion motor 25b, and the bucket conveyer motor 25c are started, and the air discharge fan 20, the discharge valve 8, the lower screw conveyer 9, the bucket conveyer 11, and the upper screw conveyer 27 are operated. Moreover, the hot-air generating burner 14 is also operated and starts generation of the hot air.

A set temperature of the hot air applied to the grain flow-down tank 5 is determined on the basis of the drying finish target moisture value set at the start of the drying operation or 15%, for example. Then, the combustion level of the hot-air generating burner 14 is changed so that the detected value of the temperature/humidity sensor 21 becomes the target temperature. The unhulled rice having flowed down from the storing portion 2 to the grain flow-down tank 5 is dried by the hot air generated by the hot-air generating burner 14. After that, it is circulated/conveyed to the storing portion 2 through the discharge portion 10, the bucket conveyer 11, and the upper screw conveyer 27, and circulation/conveyance is repeated until the moisture value of the unhulled rice measured by the moisture meter 18 at any time reaches the drying finish target moisture value. After the drying is finished, in order to prevent condensation, the normal-temperature air is applied for approximately 2 hours as necessary so as to bring a grain temperature close to an environmental temperature.

The dried unhulled rice to which the normal-temperature air has been applied is subjected to hulling by a hulling machine to obtain brown rice (S4). Subsequently, grain-sorting is performed by a rotary rice selector having a scale spacing of 1.9 mm, for example, and immature rice leaking out of the scale spacing and sieved by this is selected (S5).

Subsequently, when the immature rice with enriched GABA is crushed to the whole grain powder, the rice grains are hydrated. At this time, if the rice grains are immersed in water, there is a concern that the GABA in the rice grain elutes into the water, and thus, hydration in the air is preferable. In that case, as disclosed in Japanese Patent Laid-Open No. 2012-34665, for example, such a method is used that fine cracks are generated on the surfaces of the rice grains by applying the hot air or micro waves for a short time and after that, a moisture required for the moisture in the rice grains to rise to 20 to 30% is added in a mist state or a shower state (S6). In this method, tortoise shell or scale shaped fine cracks are generated on the surface of the rice grain and thus, the moisture easily penetrates to the inside through the cracks, and the moisture required for crushing can be uniformly added rapidly and from the whole circumferential surface of the rice grain.

Since hardness of the rice grain has lowered by the moisture penetrating to the inside of the rice grain, crushing can be made without roll crushing or the like in advance but directly by air-flow crusher or the like with smaller power (S7). As a result, fine whole-grain rice powder of immature brown rice can be obtained.

### EXAMPLES

### Example 1

In this example, unhulled rice named “Yumepirika” produced in Hokkaido in 2012 was used as a raw material, and GABA enriching treatment was executed in accordance with the aforementioned embodiment. Immature rice of approximately 13 kg was extracted from 250 kg of brown rice by a rotary rice selector with the scale spacing of 1.9 mm. A GABA value in 100 g of well-sized grains in this embodiment was 18.3 mg (dry base), while the GABA value of the immature rice was 28.4 mg. The GABA value in 100 g of the raw material before the GABA enriching treatment was 3.1 mg. Measurement of the GABA value was made by a high-speed liquid chromatograph amino-acid analysis system (by Shimadzu Corporation).

### Example 2

In this example, a raw material unhulled rice named “Hitomebore” (double-cropping rice) produced in Ishigaki-jima in 2012 was used, and the GABA enriching treatment was executed similarly to Example 1. The GABA value before the GABA enriching treatment of the raw material unhulled rice at 3.5 mg changed to the GABA value of 21.7 mg in 100 g of the well-sized grains and the GABA value of 22.3 mg of the immature rice.

TABLE 1

| | | Raw | | |
|---|---|---|---|---|
| | | material | GABA well- | GABA |
| | | unhulled | sized | immature |
| | | rice | brown rice | brown rice |
| Yumepirika | GABA | 3.1 | 18.3 | 28.4 |
| produced in | value | | | |
| Hokkkaido in | | | | |
| 2012 | | | | |
| Hitomebore | GABA | 3.5 | 21.7 | 22.3 |
| produced in | value | | | |
| Ishigaki-jima | | | | |
| in the year | | | | |
| same as above | | | | |

(unit is mg/100 g.d.b)

### Example 3

In this example, unhulled rice named “Hitomebore” produced in Ishigaki-jima in 2012 was subjected to the GABA enriching treatment similarly to the example 2 and then, GABA immature brown rice under sieve sieved by a rice selector with a scale spacing of 1.75 mm was milled and bread was baked and then, the GABA value of the raw material GABA immature brown rice powder was 22.3 mg, while crust of the bread was 14.5 mg. A center part other than the crust (bread crumb) was 22.3 mg, which was the same value as that of the raw material rice powder.

### INDUSTRIAL APPLICABILITY

The present invention can be applied in a bread making field, a cake making field, a noodle making field and the like as bread using rice powder with enriched GABA, cakes using such rice powder and the like.

### REFERENCE SIGNS LIST

1 hydrating/drying device
2 storing portion
3 air blowing duct
4 air discharge duct
5 grain flow-down tank
6 porous plate
7 hydrating/drying portion
8 discharge valve
9 lower screw conveyer
10 discharge portion
11 bucket conveyer
12 non-porous plate
13 humidifying device
14 hot-air generating burner
15 preceding air duct
16 channel switching valve
17 ventilation port
18 moisture meter
19 bypass air duct
20 air discharge fan
21 temperature/humidity sensor
22 control portion
25a fan motor
25b taking-out portion motor
25c bucket conveyer motor
27 upper screw conveyer

1. A manufacturing method of whole-grain rice powder, comprising:
applying heated/humidified air to unhulled rice and executing GABA enriching treatment on the unhulled rice;
drying the unhulled rice;
hulling the dried unhulled rice to obtain brown rice;
extracting immature brown rice from the brown rice; and
crushing the immature brown rice.

2. The manufacturing method of whole-grain rice powder according to claim 1, further comprising:
prior to the crushing, generating cracks on a surface of the immature brown rice;
hydrating the immature brown rice so that a moisture of the immature brown rice becomes 20 to 30%; and
crushing the immature brown rice.

3. A whole-grain rice powder obtained by the method according to claim 1.
